(19) United States
(12) Patent Application Publication
(10) Pub. No.: US 2008/0041876 A1
(43) Pub. Date: Feb. 21, 2008

(54) MULTI-INGREDIENT FOOD DISPENSING MACHINE

(76) Inventors: Jimmy I. FRANK, Pasadena, TX (US); Kris L. DAWSON, Pearland, TX (US); Thomas L. GUY, San Antonio, TX (US)

Correspondence Address: LOCKE LORD BISSELL & LIDDELL LLP;ATTN: IP DOCKETING, 600 TRAVIS, SUITE 3400, HOUSTON, TX, 77002-3095, US

(21) Appl. No.: 11/839,892

(22) Filed: Aug. 16, 2007

Related U.S. Application Data
(60) Provisional application No. 60/838,765, filed on Aug. 18, 2006.

(51) Int. Cl. G01F 11/00; B67D 5/56; B67D 5/62

(52) U.S. Cl. 222/1; 222/129.1; 222/146.6; 222/144.5

(57) ABSTRACT

The present disclosure provides an improved system and method that includes a food dispensing machine for dispensing a base food product through a dispensing valve and adding ingredients and other additives, such as flavors and the like, to the base food product when the product is dispensed from a product chamber. Multiple conduits coupled between additive sources and the dispensing valve can be selectively used to flow the various additives to the dispensing valve when the product is dispensed. The system and method may assist in reducing the number of product chambers generally required to deliver multiple products, allow various combinations of products, and even more combinations for those units having multiple product chambers with multiple dispensing valves. The disclosure further provides a unique valve that includes a movable nozzle assembly that unseats and seats on a fixed valve stem with attendant advantages in the above described dispensing valve.

### CROSS REFERENCE TO RELATED APPLICATIONS

This application claims the benefit of U.S. Provisional No. 60/838,765, filed Aug. 18, 2006, which is incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO APPENDIX

Not applicable.

### BACKGROUND

1. Field

The present disclosure relates generally to machines for dispensing food products such as frozen beverage and dessert machines.

2. Description of Related Art

Dispensing machines that provide a food product such as a beverage or dessert from a product chamber via a dispensing valve are well known. For example, frozen beverage machines produce a frozen beverage by freezing a mixture of ingredients such as syrup, water and carbon dioxide in a mixing, or freezing, chamber. The freezing chamber is typically surrounded by a coil that contains refrigerant to cause freezing of the mixture inside to a desired level of consistency. The mixture is removed from the inner surface and mixed by a rotating shaft driving a scraping/mixing member attached to the shaft. The frozen mixture consistency is controlled by any of a number of methods that turns on the refrigeration to freeze and turns off the refrigeration when the mixture reaches the desired consistency. The product is then dispensed through a dispensing valve.

Such beverage dispensing machines typically have a plurality of freezing chambers, each one containing a different type or flavor of beverage. However, space for installing frozen beverage dispensing machines is often at a premium, and requiring several freezing chambers to provide a variety of flavor selections uses valuable space. Further, some users desire the ability to dispense several flavors into one cup.

The present invention addresses shortcomings of the prior art.

### BRIEF SUMMARY

The present disclosure provides an improved system and method that includes a food dispensing machine for dispensing a base food product through a dispensing valve and adding ingredients and other additives, such as flavors and the like, to the base food product when the product is dispensed from a product chamber. Multiple conduits coupled between additive sources and the dispensing valve can be selectively used to flow the various additives to the dispensing valve when the product is dispensed. The system and method may assist in reducing the number of product chambers generally required to deliver multiple products, allow various combinations of products, and even more combinations for those units having multiple product chambers with multiple dispensing valves. The disclosure further provides a unique valve that includes a movable nozzle assembly that unseats and seats on a fixed valve stem with attendant advantages in the above described dispensing valve. The flow paths, additive conduits, and associated controls are generally integral with the valve and/or machine.

The disclosure provides a food dispensing machine, comprising: a product chamber for storing a base food product; a dispensing valve connected to the product chamber for selectively dispensing the food product from the product chamber; and a plurality of conduits in fluid communication with the dispensing valve, each of the conduits connectable to an additive source, the dispensing valve being adapted to mix the additive sources with the food product when the food product is dispensed from the product chamber.

The disclosure also provides a method of dispensing a food product from a food dispensing machine, comprising: providing a base food product from a product chamber; dispensing the food product from the product chamber through a dispensing valve coupled to the product chamber; and selectively adding at least one additive from a plurality of additive sources to the food product when dispensing the food product from the product chamber by flowing the additive through a conduit for the additive, the plurality of additive sources being coupled to the dispensing valve through a plurality of conduits.

The disclosure further provides a valve assembly, comprising: an inlet for receiving a fluid to be dispensed; a valve stem; and a nozzle assembly defining an outlet; the nozzle assembly being movable relative to the valve stem to selectively allow flow from the inlet to the outlet.

The disclosure still further provides a method of dispensing a fluid through a valve assembly, the valve assembly having an inlet, a nozzle assembly having an outlet, and a valve stem sealingly engageable with the nozzle assembly, comprising: receiving a fluid to be dispensed through an inlet of the valve assembly; and moving the nozzle assembly relative to the valve stem while the valve stem remains in a fixed position relative to the inlet to selectively allow flow from the inlet to the outlet.

The disclosure provides a food dispensing machine, comprising: a product chamber for storing a base food product; a dispensing valve connected to the product chamber for selectively dispensing the food product from the product chamber; and at least one conduit in fluid communication with the dispensing valve, the conduit connectable to an additive source having a fluid that is adapted to be hardenable when mixed into the food product when the food product is dispensed from the product chamber through the dispensing valve.

The disclosure also provides a method of dispensing a food product from a food dispensing machine, comprising: providing a base food product from a product chamber; dispensing the food product from the product chamber through a dispensing valve coupled to the product chamber; and selectively adding at least one hardenable fluid to the food product when dispensing the food product from the product chamber by flowing the hardenable fluid through a conduit coupled to the dispensing valve.

The disclosure further provides a food dispensing machine, comprising: a product chamber for storing a base food product; a dispensing valve connected to the product chamber for selectively dispensing the food product from the product chamber; and at least one conduit in fluid communication with the dispensing valve, the conduit connectable to an additive source having an alcoholic fluid that is adapted to be mixed into the food product when the food product is dispensed from the product chamber through the dispensing valve.

The disclosure further provides a method of dispensing a food product from a food dispensing machine, comprising: providing a base food product from a product chamber; dispensing the food product from the product chamber through a dispensing valve coupled to the product chamber; and selectively adding an alcoholic fluid to the food product when dispensing the food product from the product chamber by flowing the alcoholic fluid through a conduit coupled to the dispensing valve.

### BRIEF DESCRIPTION OF THE DRAWINGS

While the concepts provided herein are susceptible to various modifications and alternative forms, only a few specific embodiments have been shown by way of example in the drawings and are described in detail below. The figures and detailed descriptions of these specific embodiments are not intended to limit the breadth or scope of the concepts or the appended claims in any manner. Rather, the figures and detailed written descriptions are provided to illustrate the concepts to a person of ordinary skill in the art as required by 35 U.S.C. § 112.

FIG. 1 is a block diagram conceptually illustrating portions of a food dispensing machine in accordance with certain teachings of the present disclosure.

FIG. 2 is a perspective view of an exemplary embodiment of the food dispensing machine.

FIG. 3 is a side section view of a dispensing valve in accordance with certain teachings of the present disclosure, showing the valve in an open position.

FIG. 4 is a side section view of the dispensing valve, showing the valve in a closed position.

FIG. 5 is a side section view of an alternative nozzle assembly.

FIG. 6 is a perspective view of a diffusion cup used in the nozzle shown in FIG. 5.

FIG. 7 is a side view of the diffusion cup shown in FIG. 6.

FIG. 8 is a side section view of the diffusion cup shown in FIG. 6.

FIG. 9 is a side section view of another alternative nozzle assembly.

FIG. 10 is a flow diagram of the food dispensing machine.

FIG. 11 is another side section view of the dispensing valve.

FIG. 12 is a close up view of the lower portion of the valve shown in FIG. I 1.

FIG. 13 is an illustration of a valve stem for the dispensing valve.

FIG. 14 is a close up view of the lower portion of the valve stem shown in FIG. 13.

FIG. 15 is a rear view of the dispensing valve.

FIG. 16 is a front view of the dispensing valve.

### DETAILED DESCRIPTION

Illustrative embodiments of the concepts disclosed herein are presented below. In the interest of clarity, not all features of an actual implementation are described or shown in this application. It will, of course, be appreciated that in the development of an actual embodiment, numerous implementation-specific decisions must be made to achieve the developer's goals, such as compliance with system-related, business-related and other constraints, which vary by implementation and from time to time. While a developer's efforts might be complex and time-consuming, such efforts would be, nevertheless, a routine undertaking for those of ordinary skill in the art having benefit of this disclosure.

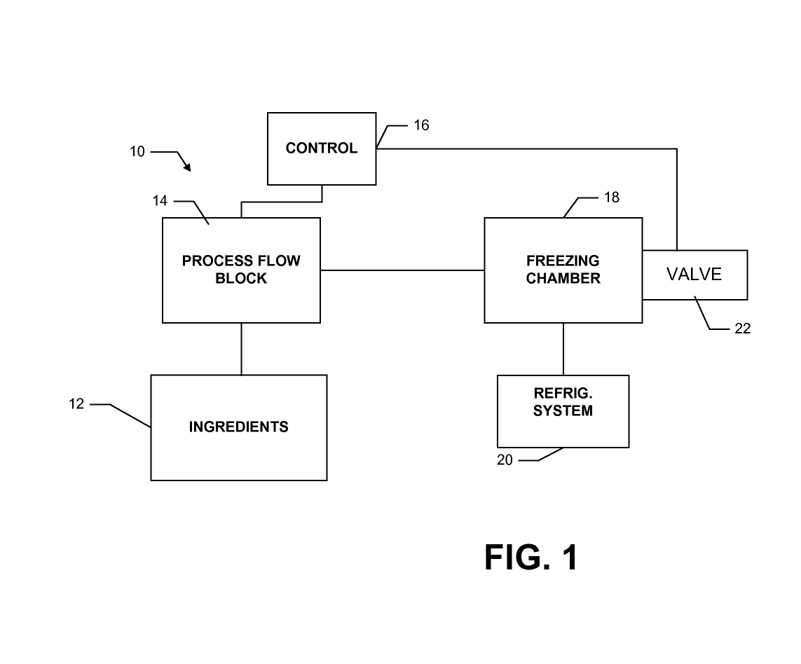

FIG. 1 is a simplified block diagram schematically illustrating components of a food dispensing machine 10 in accordance with certain teachings of the present disclosure. In FIG. 1, the food dispensing machine 10 is a frozen beverage machine. The dispensing machine 10 includes an ingredients supply source 12, a process flow block 14, a controller 16, and a product chamber 18. In the exemplary frozen beverage machine 10, the ingredient supply source 12 may include, for example, a water supply, syrup supply and a gas supply. In the illustrated embodiment, the product chamber 18 comprises a freezing chamber having a refrigeration system 20 associated therewith. Further descriptions of frozen beverage machines are provided in U.S. Pat. Nos. 5,706,661; 5,743,097; 5,799,726; 5,806,550; 6,536,224 and 6,625,993 by J. I. Frank, et al. The entire disclosures of these patents are incorporated by reference.

Ingredients for a frozen beverage mixture are provided from the ingredient supply 12 to the process flow block 14, which controls the flow of the ingredients into the freezing chamber 18 as directed by the controller 16. The controller 16 may comprise an appropriately programmed microprocessor and suitable memory devices. The frozen mixture consistency is controlled by any of a number of methods that turns on the refrigeration system 20 to freeze and turns off the refrigeration system 20 when the mixture reaches the desired consistency. Suitable operation of the controller 16 and other control instrumentation using circuit boards, volatile and non-volatile memory devices, software, firmware, and the like is described, for example, in U.S. Pat. No. 5,706,661 incorporated by reference above. The product is then dispensed through a dispensing valve 22.

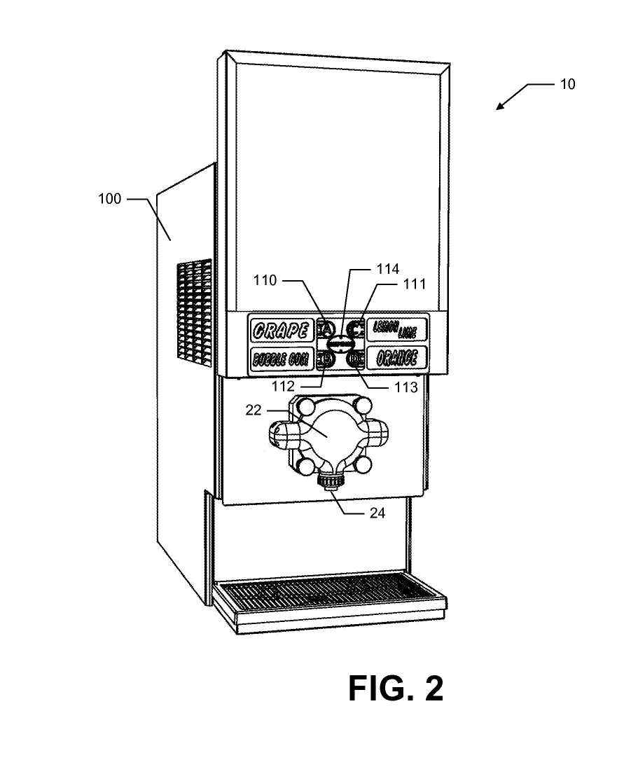

FIG. 2 is a perspective view of an exemplary embodiment of the dispensing machine 10. The various components of the machine 10 are housed in a cabinet 100, with the dispensing valve 22 mounted to the front of the cabinet 100. As noted in the background section above, known dispensing systems typically include two or more freezing chambers 18 that are cooled with a single refrigeration system 20. In accordance with exemplary embodiments disclosed herein, the exemplary system 10 includes a single chamber 18 that contains a base liquid, frozen beverage, or other base product. Generally, when the base product is dispensed, additives may be selectively injected. Thus, beverages of several different flavors can be provided without the cost and space requirements of multiple product chambers. This is advantageous in areas where a larger dispenser cannot be accommodated but multiple flavors are desired. Other embodiments are envisioned that include multiple chambers, for example, each chamber having a different base flavor to which additional flavors are injected.

The chamber 18 is coupled either directly or remotely (via a conduit that may also provide a means for circulation) to the dispensing valve 22. An actuator assembly 24 is controlled by the controller 16 to open and close the valve 22, either manually in response to actuation by a user or by a software program executed by the controller 16. The motive force to actuate the dispensing valve 22, for example, can be pressurized gas or electronic actuation via a solenoid type device. Most components of the valve assembly 22 are constructed from stainless steel. As shown in FIG. 2, the valve 22 presents a thin profile, allowing a large surface of the valve to be in direct contact with the refrigerated freezing chamber 18 in some embodiments, keeping the valve cold and retarding the growth of contaminates. Alternatively, a microbial growth inhibitor, such as Microban™, may to used in other embodiments with less contact with the freezing chamber or perhaps when the construction is made of insulative materials, such as plastics and the like.

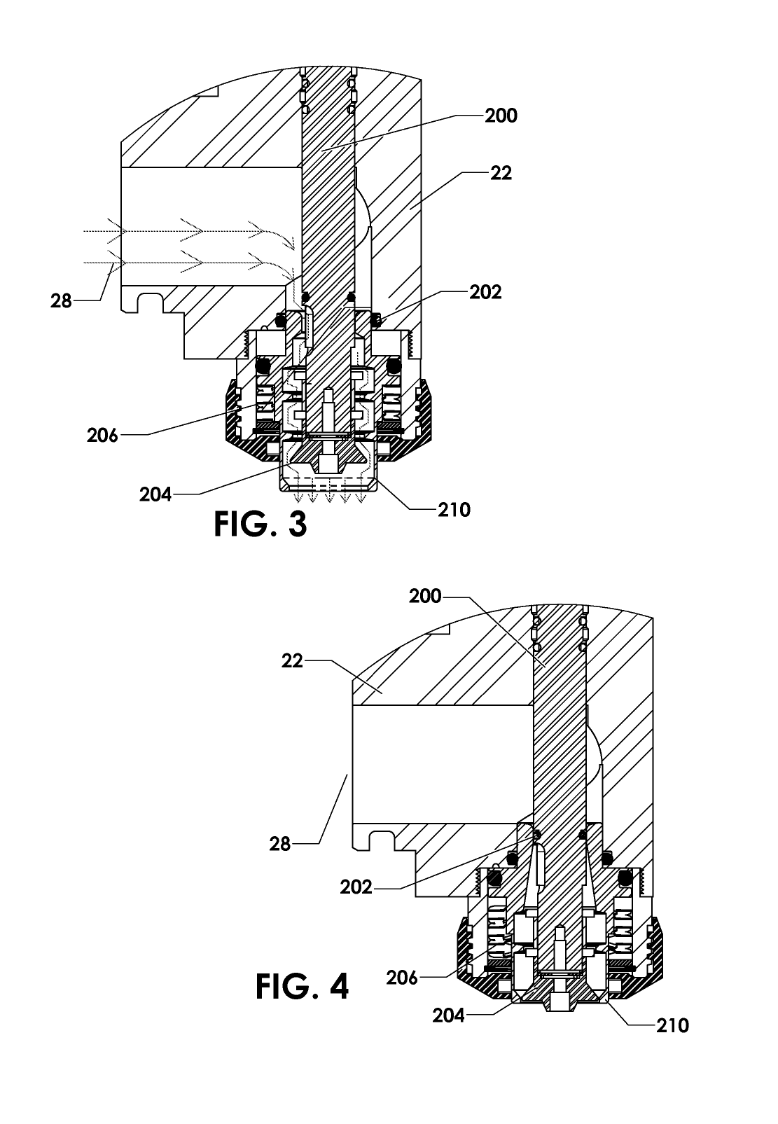

FIGS. 3 and 4 show sectional views of the valve 22 in open and closed positions, respectively. The valve 22 defines an inlet 28 that connects to the freezing chamber 18 to allow the base frozen beverage to flow into the valve 22. Since many typical food products dispensed from the machine 10 are pressurized, the product dispensed from the valve 22 may be pressurized. The design of the valve therefore insures that when the valve opens, it does not spray due to turbulence in reducing pressures from approximately 2-55 psig to atmosphere is some embodiments, and more specifically approximately 10-40 psig to atmospheric in some embodiments. An external diffuser or nozzle could help accomplish this, but such a diffuser could retain liquid that would be exposed to atmospheric conditions and possible contamination.

In a typical valve design, a stem is actuated either manually or automatically to open by raising a valve stem from a valve seat and to close by dropping the stem back into the seat. The disclosed valve 22 maintains a valve stem 200 stationary and allows a nozzle assembly 210 to move up and down to provide dispensing or sealing. By doing this, when the valve 22 opens and the nozzle assembly 210 drops down to initiate flow, the nozzle assembly 210 provides a partial barrier to the spray that results from the depressurized liquid. In order to allow the nozzle assembly to drop down far enough to provide an effective nozzle length, the illustrated embodiment includes an upper seal 202 is provided that maintains its seal until a lower seal 204 is unseated. This allows a partial drain and the reduction of any pressure built up in the valve cavity. This also reduces the hydraulic effect on the valve cavity that causes spraying prior to the extension of the nozzle assembly. In other embodiments, the lower seal 204 is not used.

Since the liquid retained in the valve would be trapped in an area that would be sealed at the top entry to the valve cavity by the upper seal 202 in addition to the lower seal 204 at the exit to the valve cavity, the stem 200 and the seals 202, 204 are designed such that when the valve closes the upper seal 202 first allowing the liquid trapped to partially drain prior to the lower seal 204 seating thus preventing pressure from being trapped in the valve cavity. If the pressure were trapped, the valve may “spit” upon opening. In addition, when the valve opens, the lower seal 204 unseats first allowing the nozzle assembly 210 to drop down far enough to prevent spray prior to the upper seal 202 coming off its seat and also release any pressure in the valve cavity.

The illustrated valve 22 is microprocessor controlled and is actuated by opening a gas solenoid that directs pressurized gas to a pressure plate that is attached to the valve nozzle assembly 210. When the valve 22 is actuated, the nozzle assembly 210 lowers, placing force against springs 206 that maintain the valve in the closed position when the valve is not in use. The springs 206 are designed such that they will not allow the valve to open under any normal operating pressures. In the event of an overpressure of the freezing chamber 18, the springs 206 are sized to act as a safety vent to prevent rupture of any component.

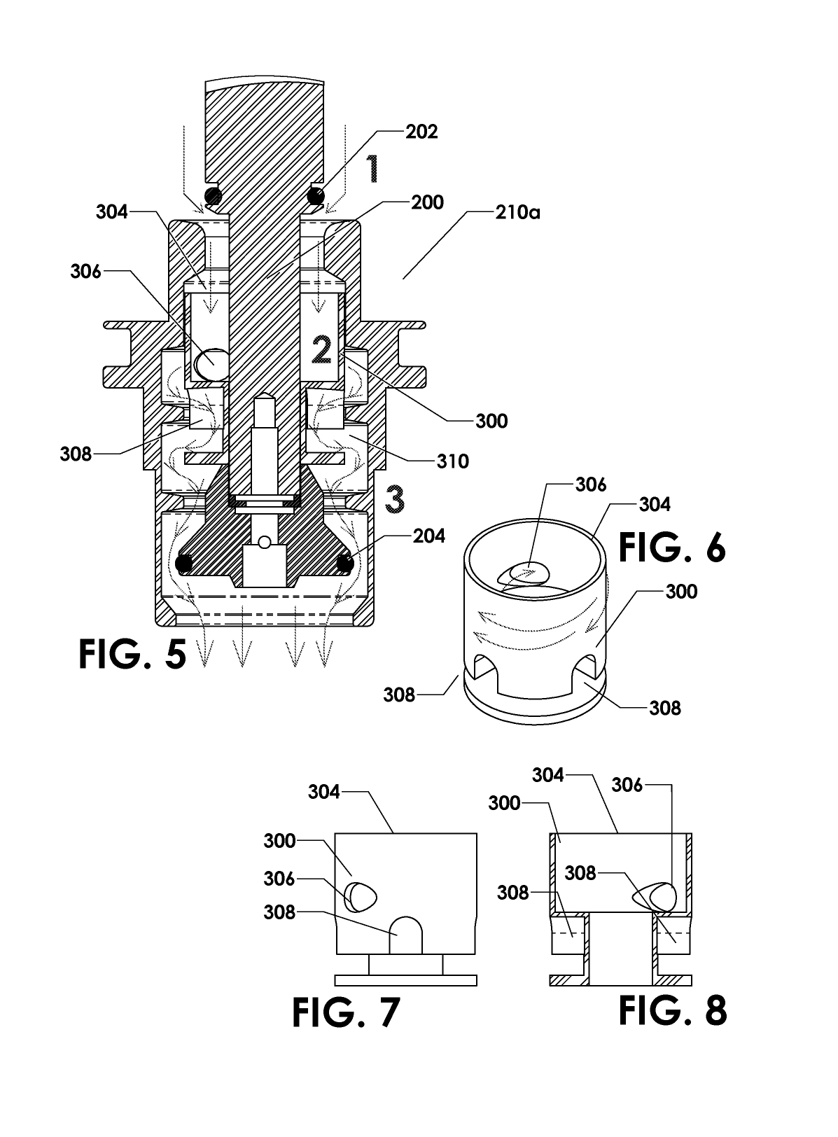

As noted above, typical products dispensed from the machine 10 are pressurized. Additional valve arrangements are disclosed herein to dispense the pressurized product. An alternative nozzle assembly 210a is shown in FIG. 5. The nozzle assembly 210a includes a diffusion cup 300, which is shown in additional detail in FIGS. 6, 7, and 8. Product enters the nozzle assembly 210a and flows into a diffusion cup 300 via an inlet opening 304. The product flows out of a side opening 306, causing the product to swirl and fill a cavity 310 defined by the nozzle assembly 210a outside the diffusion cup 300. The lower part of the diffusion cup 300 defines four slots 308, which curl the product towards the center of the nozzle assembly 210a. The product then continues through the nozzle assembly 210a and out through the nozzle outlet.

The valve stem 200 and/or the nozzle assembly 210 may be shaped to include a flow path that dispenses the product in a variety of shapes. For example and without limitation, such shapes can include swirls, stripes, inward swirls that are surrounded by a layer of base material, external swirls that surround base material, and other shapes. Further, the valve stem 200 and/or the nozzle assembly 210 may include a tip (not shown) that is removable or fixed to the valve stem and/or the nozzle assembly to assist in dispensing the product into the desired shape.

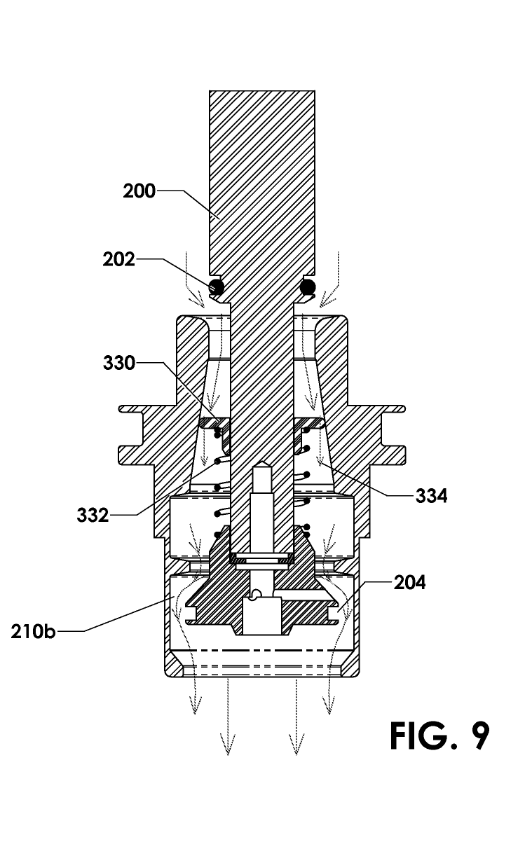

FIG. 9 shows another exemplary nozzle assembly 210b that includes a spring-loaded diffusion plate 330 for absorbing some of the energy of the pressurized product. A spring 332 is situated between the plate 330 and a lower portion of the valve stem 200. When the pressurized product flows into the nozzle assembly 210b, it depresses the plate 330 against the spring 332, moving the plate 330 down allowing the product to flow through the nozzle assembly 210b. As the pressure of the dispensed product varies, the spring-loaded plate 330 will react to the change, opening more for higher pressures. The angled inside wall 334 of the nozzle assembly 210b, together with the appropriate spring tension allow for a more uniform flow of product, regardless of its pressure.

Referring back to FIG. 2, the valve 22 is designed to be actuated manually by pressing a dispense button 114 that interacts with the controller 16. In other embodiments, an automated cleaning and sanitizing process is provided, and the valve 22 is controlled by a computer program executed by the controller 16 that instructs the valve 22 when to open and when to close in order to effect the cleaning and sanitizing process. The valve 22 could also be actuated with a manual valve handle actuating a switch to open.

The machine 10 shown in FIG. 2 includes four different flavors, though the number of flavors provided can vary depending on the number of flow conduits provided in the stem area. The various flavors can be combined with the base frozen beverage dispensed from the chamber 18. One or more of the actuation buttons 110, 111, 112, 113 are activated by a user to add the desired one or more flavors to the base beverage.

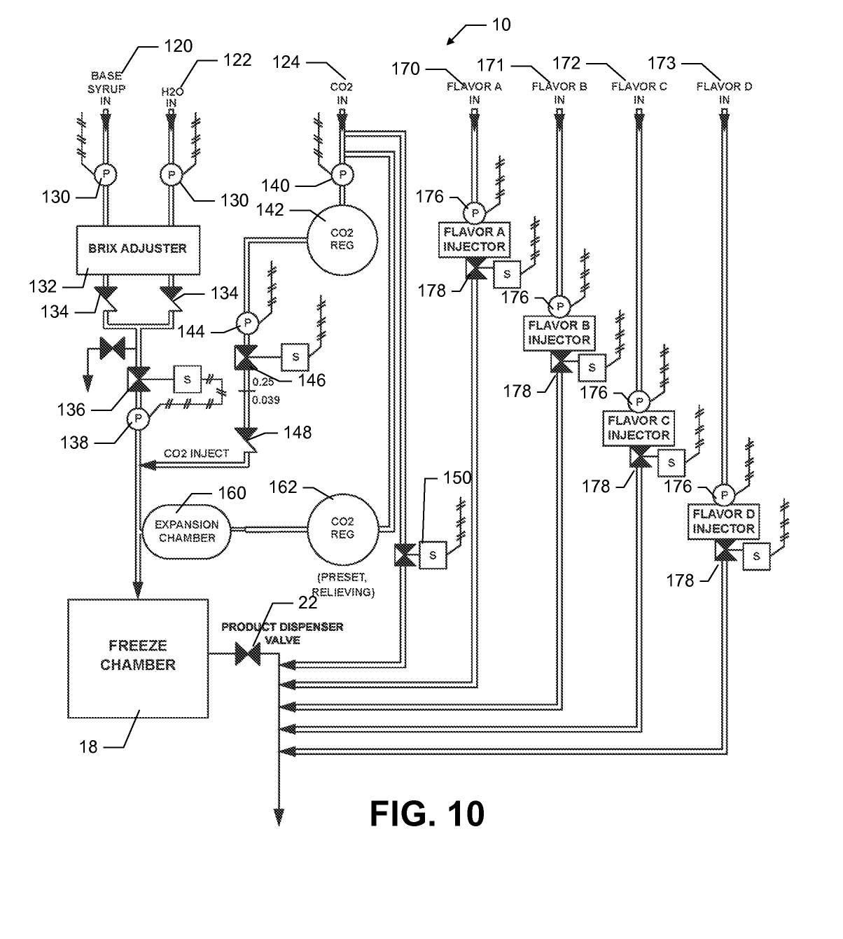

FIG. 10 is a flow diagram for the machine 10. The ingredients for the base beverage, for example syrup 120, water 122 and carbon dioxide 124 flow to the freezing chamber 18. The base syrup and water flow through pressure transducers 130 to a brix adjuster 132 and check valves 134 at the outlet of the brix adjuster 132 before combining into a single line and flowing to the freezing chamber 18 via a solenoid 136 and a pressure transducer 138. The carbon dioxide 124 flows into the freezing chamber via a pressure transducer 140, a regulator 142, another pressure transducer 144, a solenoid 146 and a check valve 148. In addition to providing carbonation for the base beverage in the freezing chamber 18, the carbon dioxide 124 provides the actuation means for the valve 22 via a solenoid 150. The carbon dioxide line is further connected to an expansion chamber 160 via a regulator 162 to provide an active charge to the expansion chamber 160. A fixed charge in the expansion chamber 160 has a tendency to leak, and therefore must be periodically replaced. In other embodiments, for example, a version dispensing a non-carbonated beverage, an additional source of compressed gas may be used as an actuation means.

In the illustrated machine, four flavors are dispensed to the beverage downstream of the freezing chamber 18. Each of the flavor additives 170, 171, 172, 173 flow via respective lines to the dispensing valve 22. Flow control devices, such as the illustrated pressure transducers 176 and solenoids 178 are used to inject the desired flavor(s) in response to the particular actuation buttons 110, 111, 112, 113.

While the illustrated embodiment shows different flavors being introduced to the dispensed product, any of a number of nutritional or supplement additives can be introduced to the dispensed product to meet the specific needs or desires of the individual served. The dispensed product may, for example, include supplements to provide a meal replacement option with desired additives of importance, such as calcium, vitamin C, medicinal additives, or herbal additives.

Further, the additives can include solids, semi-solids, or fluids (such as liquids or gels) that may harden to form solids or semi-solids after being added to the base food product. Such additives may further allow material to be added to produce a different textured product than heretofore may have been available, due to the prior lack of ability to process such additives in the freezing chamber prior to dispensing. Such options may especially be available using fluids that may form solids or semi-solids upon injecting into the food product when the food product is dispensed. Such material can be process through the small restrictions in the flow control devices and supply line components.

The dispensed product may also include alcohol products, which are injected in the same manner as the above additives after the freezing chamber. An advantage of adding these components at the point of dispense instead of premixed into the dispensed product is that they are less likely to de-stabilize the base product being served and may not effect the ultimate flavor since they are exposed just prior to consumption and not premixed for long periods of time. Further, some licensing aspects of supplying alcohol as a pre-mixed additive with base material may be avoided by injecting the alcohol directly into the food product as it is dispensed at the point of use, where a store has such licenses to supply the alcohol. Such direct injection may also provide a better and more accurately monitored and controlled amount of alcohol in the product.

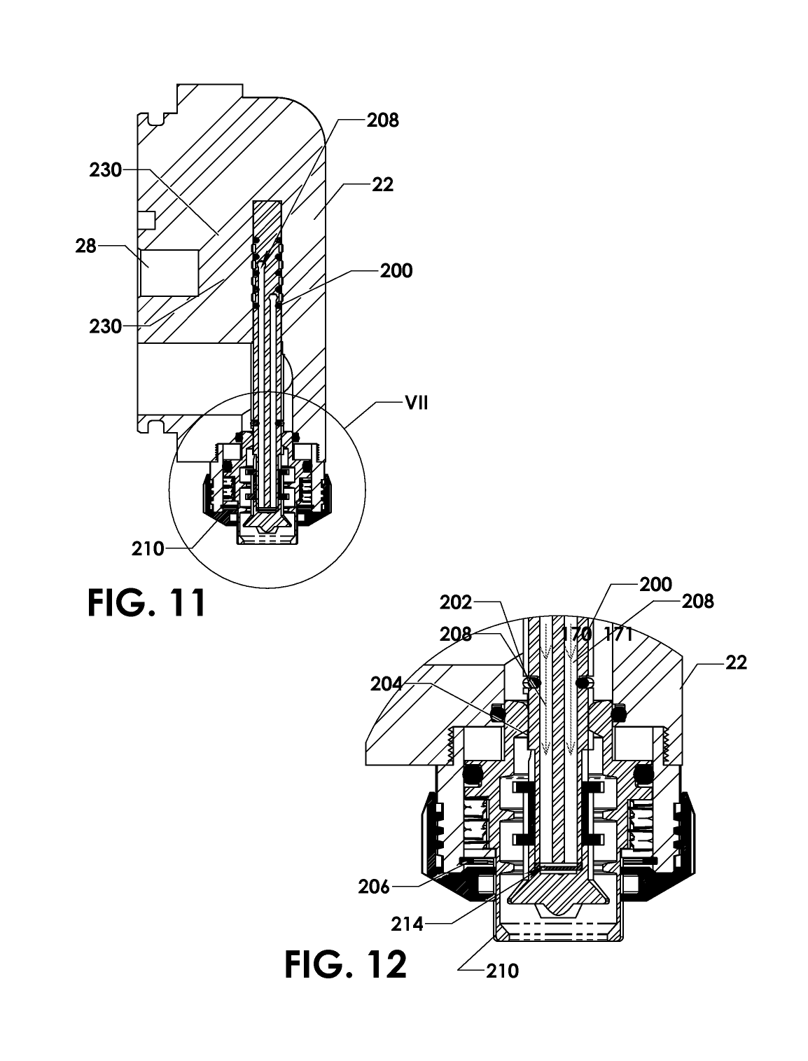

FIG. 11 is another side view of the dispensing valve 22, shown in section. The dispensing valve 22 has a stationary stem 200 through which numerous additives may be introduced through channels 208 defined within the stem. The valve 22 is actuated by moving the nozzle assembly 210 down and out of sealing position from the stationary stem 200, through which the additives flow. FIG. 12 is a close up view of the lower portion of the valve 22 identified as VII, including the nozzle assembly 210 and part of the stem 200.

Two of the channels 208 for the additives (flavors in the illustrated embodiment) 170, 171 are shown in FIG. 12. The flavor additives proceed down the length of the stem 200 via the associated channel 208 to a distribution area designed to distribute the additive into the product stream. The pattern that is created in the product stream is created by the design of the nozzle assembly 210 and the stem 200 at the point of injection or after injection.

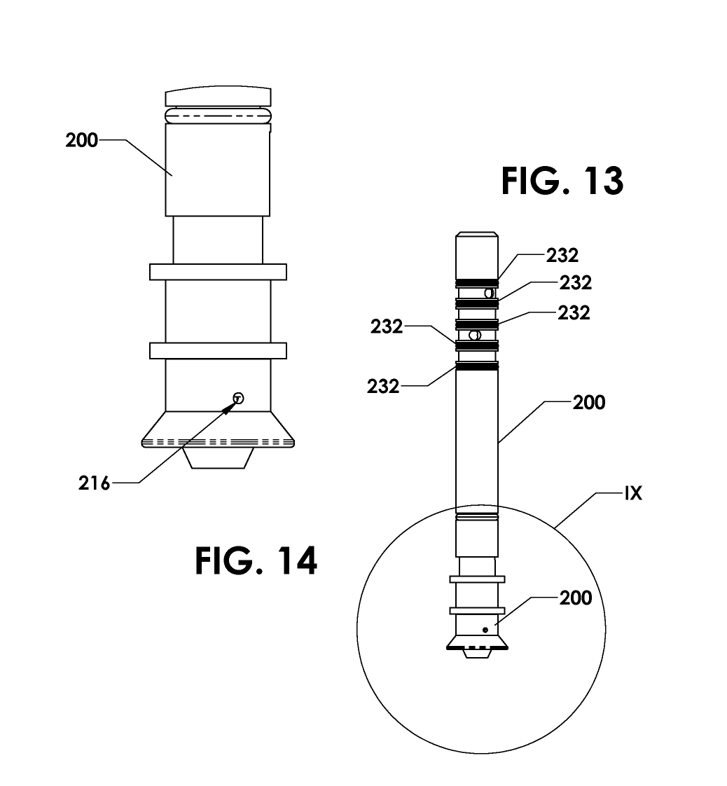

FIG. 13 is an illustration of a valve stem for the dispensing valve. FIG. 14 is a close up view of the lower portion of the valve stem shown in FIG. 13. The figures will be described in conjunction with each other. FIG. 13 shows the stem 200, and FIG. 14 shows the lower portion of the stem 200, identified as IX. The flavors 170-173 are driven through a diffusion plate 214 and then dispersed into the main flow of the base beverage through ports 216 defined in the stem 200. The flavors or other additives can be introduced into the base beverage at any location downstream of a sealing device, such the seal 202. The position at which the flavors 170-173 are introduced will create any number of interesting mixing patterns in the dispensed product. The geometry of the nozzle internal diameter will also impact on the injection pattern of the additive in the product stream. As an example, the additive can be injected so that the pattern provides a swirling effect, a straight line down one or more sides of the dispensed stream or a thoroughly mixed additive which provides many flavors out of one barrel. This would in effect provide the same benefit as a machine having two, three, or more chambers.

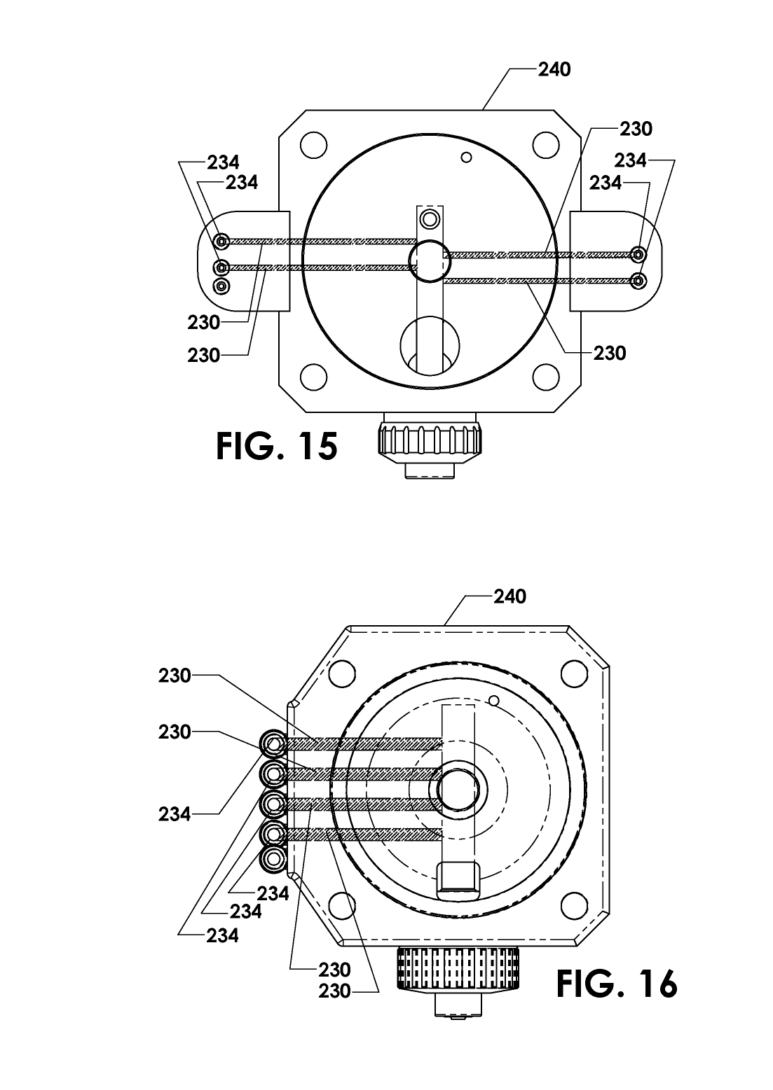

FIG. 15 is a rear view of the valve 22. FIG. 16 is a front view of the valve. The figures will be described in conjunction with each other. In the illustrated embodiment, the additives are introduced to the channels 208 via conduits 230 formed in the faceplate 240 that holds the valve stem 200 and sealed from the other flavor additives by o-rings 232 along the outside diameter of the stem 200. Connectors 234 at the ends of the conduits 230 opposite the valve stem 200 connect to tubes providing the various flavor additives 170-173. In other embodiments, the additives are introduced with tubes that attach mechanically to corresponding openings in the stem that intersect the appropriate additive channel 208. Moreover, in the illustrated embodiments, the additives are added to a nozzle assembly that operates by moving the nozzle assembly relative to a fixed valve stem. In other embodiments, the additives are added using a nozzle assembly that remains fixed with a movable valve stem.

The software executed by the controller 16 is designed to allow one or all of the additives 170-173, or combinations thereof, selected to be injected into the dispensed product stream. The controller 16 can also control the additive flows, so that each additive can alternatively injected by pulsing the corresponding additive solenoid valve 178. The additives, such as desired beverage flavors, can be pulsed in any desired sequence in response to the chosen flavors. This pulsing provides various colors and patterns in the dispensed product and can also be used to control the amount of the additive flow.

While the dispensing machine has been primarily disclosed in terms of frozen beverages, the basic dispensing machine can be used to dispense hot beverages, cold beverages, frozen beverages, frozen desserts, etc. For example, for hot beverages such as coffee-based drinks, a heated product chamber would be used in place of the freezing chamber 18. Additives can be metered into any variety of dispensed products.

The systems and methods herein have been described in the context of various embodiments and not every embodiment has been described. Apparent modifications and alterations to the described embodiments are available to those of ordinary skill in the art. The disclosed and undisclosed embodiments are not intended to limit or restrict the scope or applicability of the concepts of the Applicants, but rather, in conformity with the patent laws, Applicants intend to protect all such modifications and improvements to the full extent that such falls within the scope or range of equivalent of the following claims.

The various methods and embodiments of the disclosure may be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the disclosure. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof Discussion of singular elements may include plural elements and vice-versa. References to at least one item followed by a reference to the item may include one or more items. The device or system may be used in a number of directions and orientations. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and may further include without limitation integrally forming one functional member with another in a unity fashion. The coupling may occur in any direction, including rotationally.

The order of steps may occur in a variety of sequences unless otherwise specifically limited. The various steps described herein may be combined with other steps, interlineated with the stated steps, and/or split into multiple steps. Additionally, the headings herein are for the convenience of the reader and are not intended to limit the scope of the disclosure. Other and further embodiments utilizing one or more aspects of the concepts described above may be devised without departing from the spirit of Applicants' disclosure. Other variations are contemplated given the teachings of the disclosure herein.

Further, any references mentioned in the application for this patent, as well as all references listed in the information disclosure originally filed with the application, are hereby incorporated by reference in their entirety to the extent such may be deemed essential to support the enabling of the disclosure. However, to the extent statements might be considered inconsistent with the patenting of the concepts, such statements are expressly not meant to be considered as made by the Applicant(s).

1. A food dispensing machine, comprising:
a product chamber for storing a base food product;
a dispensing valve connected to the product chamber for selectively dispensing the food product from the product chamber; and
a plurality of conduits in fluid communication with the dispensing valve, each of the conduits connectable to an additive source, the dispensing valve being adapted to mix the additive sources with the food product when the food product is dispensed from the product chamber.

2. The food dispensing machine of claim 1, further comprising a controller adapted to allow a user to select different additive sources through the dispensing valve to add to the food product when the food product is dispensed from the product chamber.

3. The food dispensing machine of claim 2, wherein at least one of the additive sources comprises a fluid that hardens after being added to the food product when the food product is dispensed from the product chamber.

4. The food dispensing machine of claim 1, wherein at least one of the additive sources comprises an alcoholic additive.

5. The food dispensing machine of claim 1, wherein the controller is adapted to allow addition of different additives at different times when the food product is dispensed from the product chamber.

6. The food dispensing machine of claim 1, further comprising:
a plurality of product chambers having one or more base food products;
a plurality of dispensing valves connected to the plurality of product chambers for selectively dispensing the food products from the product chambers; and
a plurality of conduits in fluid communication with the dispensing valves, each of the conduits connectable to an additive source, the dispensing valves being adapted to mix the additive sources with the food products when the food products are dispensed from the product chambers.

7. The food dispensing machine of claim 1, wherein the dispensing valve includes a nozzle assembly that is movable relative to a fixed valve stem.

8. The food dispensing machine of claim 7, wherein the nozzle assembly, valve stem, or a combination thereof is shaped to provide a pattern to the food product when the food product is dispensed through the dispensing valve.

9. The food dispensing machine of claim 7, wherein the nozzle assembly is adapted to form a partial barrier to a product spray caused by flowing a depressurized product from the dispensing valve when the nozzle assembly is unseated from the fixed valve stem.

10. The food dispensing machine of claim 1, wherein the food product comprises a frozen beverage and the additive sources for the conduits comprises flavor sources, and wherein the dispensing valve is adapted to mix different flavors into the frozen beverage when the frozen beverage is dispensed from the product chamber.

11. A method of dispensing a food product from a food dispensing machine, comprising:
providing a base food product from a product chamber;
dispensing the food product from the product chamber through a dispensing valve coupled to the product chamber; and
selectively adding at least one additive from a plurality of additive sources to the food product when dispensing the food product from the product chamber by flowing the additive through a conduit for the additive, the plurality of additive sources being coupled to the dispensing valve through a plurality of conduits.

12. The method of dispensing a food product of claim 11, further comprising allowing a user to selectively control the addition of one or more additives at different times when dispensing the food product through the dispensing valve.

13. The method of dispensing a food product of claim 12, further comprising adding a fluid additive to the food product that hardens after being added to the base food product when dispensing the food product through the dispensing valve.

14. The method of dispensing a food product of claim 12, further comprising adding an alcoholic additive to the base food product when dispensing the food product through the dispensing valve.

15. The method of dispensing a food product of claim 11, further comprising:
providing one or more base food products in a plurality of product chambers coupled to a plurality of dispensing valves, each dispensing valve having a plurality of conduits coupled to a plurality of additive sources;
dispensing one or more food products from the product chambers through one or more of the dispensing valves; and
selectively adding at least one additive from the plurality of additive sources to the one or more food products when dispensing the food products from the product chambers by flowing the additive through a conduit for the additive.

16. The method of dispensing a food product of claim 11, further comprising moving a nozzle assembly in the dispensing valve relative to a fixed valve stem to control the dispensing of the food product.

17. The method of dispensing a food product of claim 16, forming a pattern to the food product when the food product is dispensed through the dispensing valve.

18. The method of dispensing a food product of claim 16, further comprising at least partially blocking a product spray caused by flowing a depressurized food product from the dispensing valve when the nozzle assembly is unseated from the fixed valve stem.

19. The method of dispensing a food product of claim 11, wherein the food product comprises a frozen beverage and the additive sources for the conduits comprises flavor sources, and further comprising mixing different flavors into the frozen beverage when dispensing the frozen beverage from the product chamber.

20. A valve assembly, comprising:
an inlet for receiving a fluid to be dispensed;
a valve stem; and
a nozzle assembly defining an outlet; the nozzle assembly being movable relative to the valve stem to selectively allow flow from the inlet to the outlet.

21. The valve assembly of claim 14, wherein the valve stem and nozzle assembly form first and second seals therebetween when the valve assembly is in a closed position, the first seal being closer to the inlet than the second seal, and wherein the second seal is adapted to unseat before the first seal when the nozzle assembly is moved from the closed position to an open position.

22. The valve assembly of claim 14, wherein the nozzle assembly includes a diffusion cup.

23. The valve assembly of claim 14, wherein the nozzle assembly includes a spring-loaded diffusion plate.

24. The valve assembly of claim of claim 14, wherein the nozzle assembly, valve stem, or a combination thereof is shaped to provide a pattern to a fluid when the fluid is dispensed through the valve assembly.

25. A method of dispensing a fluid through a valve assembly, the valve assembly having an inlet, a nozzle assembly having an outlet, and a valve stem sealingly engageable with the nozzle assembly, comprising:
receiving a fluid to be dispensed through an inlet of the valve assembly; and
moving the nozzle assembly relative to the valve stem while the valve stem remains in a fixed position relative to the inlet to selectively allow flow from the inlet to the outlet.

26. The method of claim 25, further comprising shaping the fluid in a pattern when dispensing the fluid.

27. The method of dispensing the fluid of claim 25, wherein the valve stem and nozzle assembly form first and second seals therebetween when the valve assembly is in a closed position, the first seal being closer to the inlet than the second seal, and further comprising unseating the second seal before the first seal when moving the nozzle assembly from the closed position to an open position.

28. The method of dispensing the fluid of claim 25, further comprising injecting a second fluid into the dispensing fluid, the second fluid forming a hardened material after injecting into the dispensed fluid.

29. A food dispensing machine, comprising:
a product chamber for storing a base food product;
a dispensing valve connected to the product chamber for selectively dispensing the food product from the product chamber; and
at least one conduit in fluid communication with the dispensing valve, the conduit connectable to an additive source having a fluid that is adapted to be hardenable when mixed into the food product when the food product is dispensed from the product chamber through the dispensing valve.

30. The food dispensing machine of claim 29, wherein the hardenable fluid is adapted to become solid or semi-solid when mixed into the food product.

31. The food dispensing machine of claim 29, further comprising a controller adapted to control the fluid mixed into the food product.

32. The food dispensing machine of claim 29, wherein the dispensing valve includes a nozzle assembly that is movable relative to a fixed valve stem.

33. The food dispensing machine of claim 32, wherein the nozzle assembly, valve stem, or a combination thereof is shaped to provide a pattern to the food product when the food product is dispensed through the dispensing valve.

34. The food dispensing machine of claim 29, wherein the food product comprises a frozen beverage and the additive source for the conduit comprises a hardenable fluid flavor, and wherein the dispensing valve is adapted to mix the hardenable fluid flavor into the frozen beverage when the frozen beverage is dispensed from the product chamber.

35. A method of dispensing a food product from a food dispensing machine, comprising:
providing a base food product from a product chamber;
dispensing the food product from the product chamber through a dispensing valve coupled to the product chamber; and
selectively adding at least one hardenable fluid to the food product when dispensing the food product from the product chamber by flowing the hardenable fluid through a conduit coupled to the dispensing valve.

36. The method of dispensing a food product of claim 35, further comprising selectively controlling the adding of hardenable fluid at different times when dispensing the food product through the dispensing valve.

37. The method of dispensing a food product of claim 35, further comprising moving a nozzle assembly in the dispensing valve relative to a fixed valve stem to control the dispensing of the food product.

38. The method of dispensing a food product of claim 37, forming a pattern to the food product when the food product is dispensed through the dispensing valve.

39. The method of dispensing a food product of claim 35, wherein the food product comprises a frozen beverage and further comprising mixing the hardenable fluid into the frozen beverage when dispensing the frozen beverage from the product chamber.

40. A food dispensing machine, comprising:
a product chamber for storing a base food product;
a dispensing valve connected to the product chamber for selectively dispensing the food product from the product chamber; and
at least one conduit in fluid communication with the dispensing valve, the conduit connectable to an additive source having an alcoholic fluid that is adapted to be mixed into the food product when the food product is dispensed from the product chamber through the dispensing valve.

41. The food dispensing machine of claim 40, further comprising a controller adapted to control the alcoholic fluid mixed into the food product.

42. The food dispensing machine of claim 40, wherein the dispensing valve includes a nozzle assembly that is movable relative to a fixed valve stem.

43. The food dispensing machine of claim 42, wherein the nozzle assembly, valve stem, or a combination thereof is shaped to provide a pattern to the food product when the food product is dispensed through the dispensing valve.

44. The food dispensing machine of claim 40, wherein the food product comprises a frozen beverage and wherein the dispensing valve is adapted to mix the alcoholic fluid into the frozen beverage when the frozen beverage is dispensed from the product chamber.

45. A method of dispensing a food product from a food dispensing machine, comprising:
providing a base food product from a product chamber;
dispensing the food product from the product chamber through a dispensing valve coupled to the product chamber; and
selectively adding an alcoholic fluid to the food product when dispensing the food product from the product chamber by flowing the alcoholic fluid through a conduit coupled to the dispensing valve.

46. The method of dispensing a food product of claim 45, further comprising selectively controlling the addition of the alcoholic fluid at different times when dispensing the food product through the dispensing valve.

47. The method of dispensing a food product of claim 45, further comprising moving a nozzle assembly in the dispensing valve relative to a fixed valve stem to control the dispensing of the food product.

48. The method of dispensing a food product of claim 47, forming a pattern to the food product when the food product is dispensed through the dispensing valve.

49. The method of dispensing a food product of claim 45, wherein the food product comprises a frozen beverage and further comprising mixing the alcoholic fluid into the frozen beverage when dispensing the frozen beverage from the product chamber.
